(19) United States
(12) Patent Application Publication
(10) Pub. No.: US 2011/0123038 A1
(43) Pub. Date: May 26, 2011

(54) CHAIR-ATTACHABLE WIRELESS SPEAKER SYSTEM

(76) Inventor: Rex Clark, Vancouver, WA (US)

(21) Appl. No.: 12/625,120

(22) Filed: Nov. 24, 2009

(51) Int. Cl. H04B 3/00; H04R 1/02

(52) U.S. Cl. 381/77; 381/333

(57) ABSTRACT

A wireless speaker system comprising a speaker unit, a transmitter unit with an audio source input, in radio frequency communication with a receiver unit, where the speaker unit and receiver unit can be forcefully attached to the back of a chair so that the speaker unit is positioned next to the user's ear or ears while the user is sitting in the chair. Attachment is provided by positive force onto the back of a chair from one or more chair attach straps. A chair attach strap is a long wide strap draped over the back of an easy chair with speaker unit on one end and receiver unit on the other end. Clamping force may be provided by springs, gravity, or other force. The wireless speaker system has range of about 50 meters and is designed for home use with special application for the hearing impaired.

### BACKGROUND OF THE INVENTION

1. Field of the Invention

This invention pertains to a wireless speaker system comprising a transmitter unit with an audio source input in radio frequency communication with a receiver unit electrically connected to a speaker unit, where the receiver unit and speaker unit can be forcefully attached to the back of a chair so that the speaker unit is positioned next to the user's ear or ears while the user is sitting in the chair.

2. Description of Related Art

There are many wireless speaker systems in the prior art with a transmitter unit connected to an audio source and a receiver unit with left and right speakers.

Several wireless speaker systems are marketed under the registered trademark “TV Ears”. With these devices, the left and right speakers are incorporated into a head set or into a speaker box. Neither the headset nor the speaker box is chair-attachable. Also, the transmitter and receiver of this device communicate through infrared optical signals, while this invention uses radio frequency communication for this purpose.

There are several patent publications that disclose wireless speaker systems. Schotz et al. has three patent publications that appear to be some of the most pertinent, namely U.S. Pat. No. 5,673,323, U.S. Pat. No. 5,832,024, and U.S. Pat. No. 5,946,343. With these devices, a transmitter transmits a digital radio frequency signal to a receiver, as does this invention. However, Schotz does not disclose a wireless speaker system with a playback portion in the exterior form of structure used to forcefully attach to the back of a chair.

### BRIEF SUMMARY OF THE INVENTION

It is an aspect of this invention to provide a wireless speaker system with left and right speakers that can be easily attached to the back of a chair so that said speakers may be located next to the user's ear or ears while the user is sitting in the chair.

The chair-attachment aspect is affirmative or positive in nature, so that the speakers are firmly attached, using positive pressure, to the back of the chair, and remain so during possible chair reclining or other actions causing similar small movements of the chair.

The chair-attachment aspect allows for speaker positioning and location so that the speakers will not interfere with the function of the chair, i.e. the user sitting down, remaining seated, reclining, getting up from the chair, etc. Thus, the user can install the invention onto a chair and then freely get up and sit down in the chair without obstruction from the invention and can control the invention in sitting position in the chair also without interference with chair function.

It is an aspect of this invention to provide a wireless speaker system with a volume control and a mute switch near one of the speakers.

It is an aspect of the invention for the transmitter unit to include: an RCA audio analog input, an optical audio digital input, and a coaxial audio cable digital input.

It is an aspect of this invention to electrically process the signal from any one of the above listed audio inputs into a digital radio frequency format and transmit such to a receiver unit, where the digital radio frequency transmission is received by the receiver and electrically processed into a left and a right speaker analog sound signal that is in good quality to deliver clear sound from the speakers when delivered to the left and right speakers.

### BRIEF DESCRIPTION OF THE DRAWINGS

FIG. 1 is a top view of best mode, with the system placed on a flat surface.

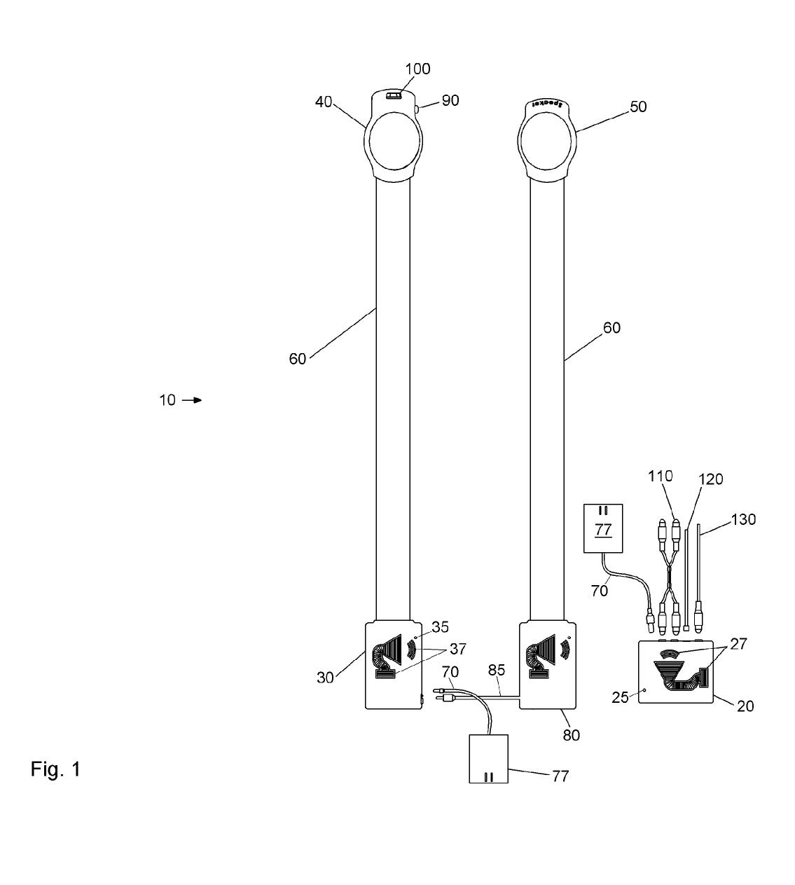

FIG. 2 is a perspective view of best mode, with the system placed on a flat surface.

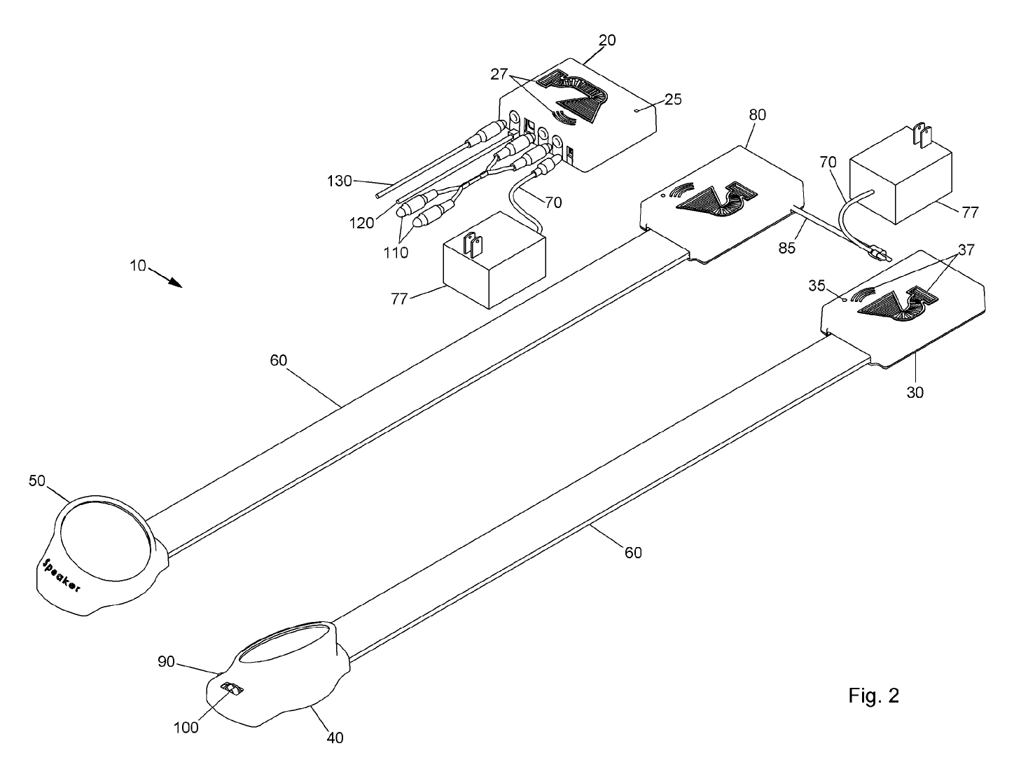

FIG. 3 is a perspective view of best mode as it would appear in typical use, attached to a chair.

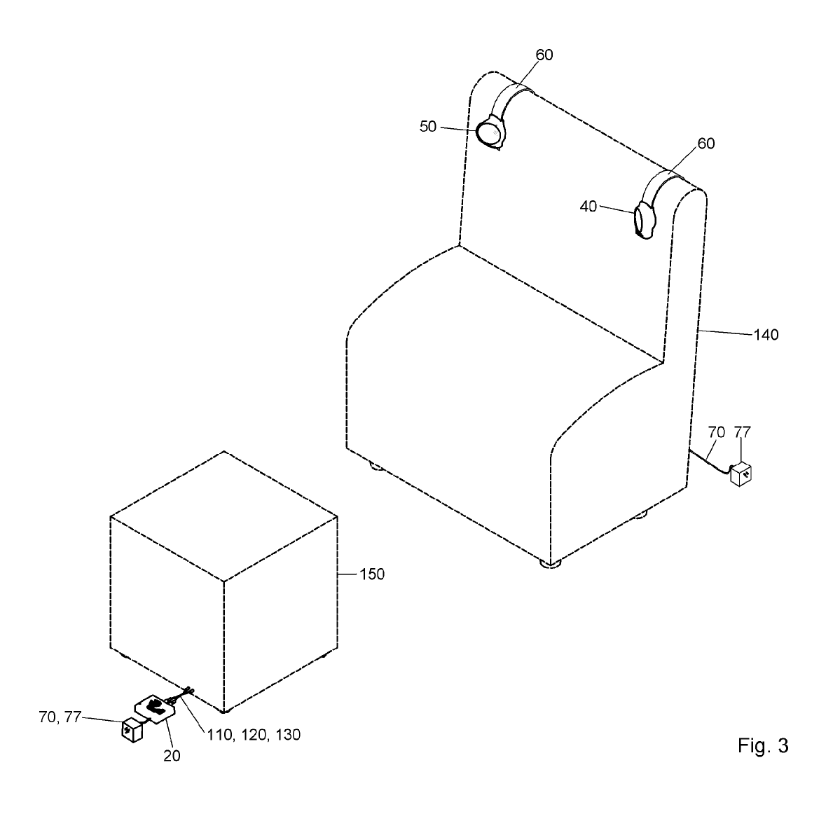

FIG. 4 is a side view of best mode as it would appear in typical use, attached to a chair.

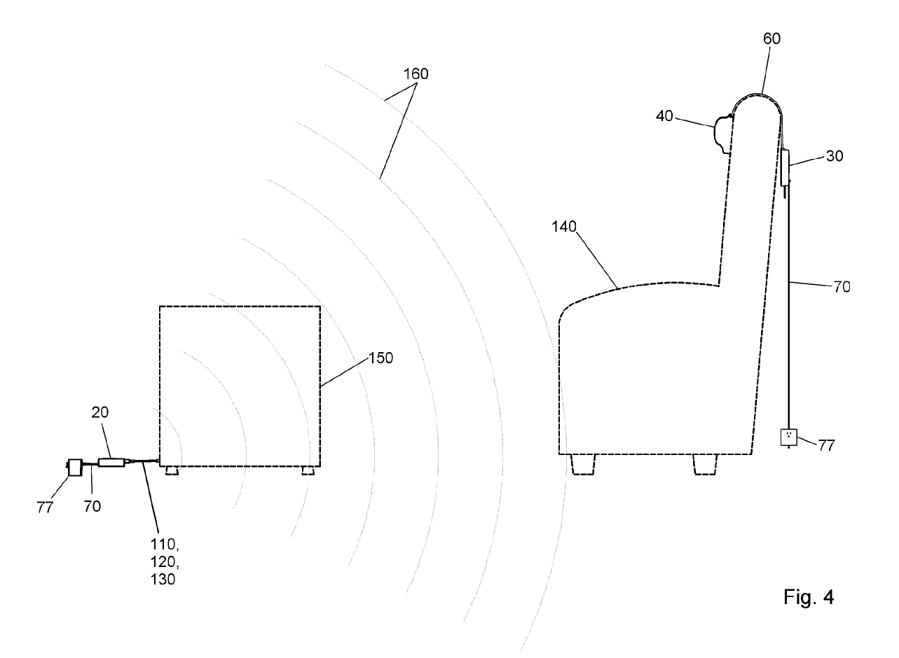

FIG. 5 is a back view of best mode as it would appear in typical use, attached to a chair.

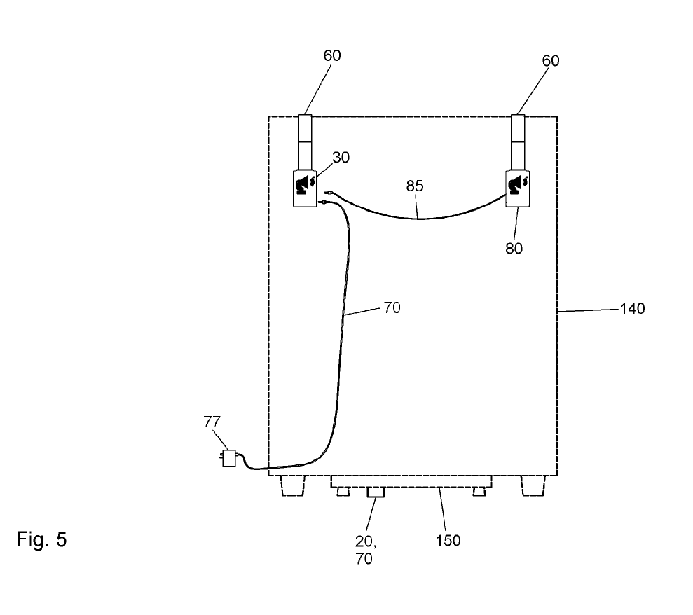

FIG. 6 is a top view of best mode as it would appear in typical use, attached to a chair.

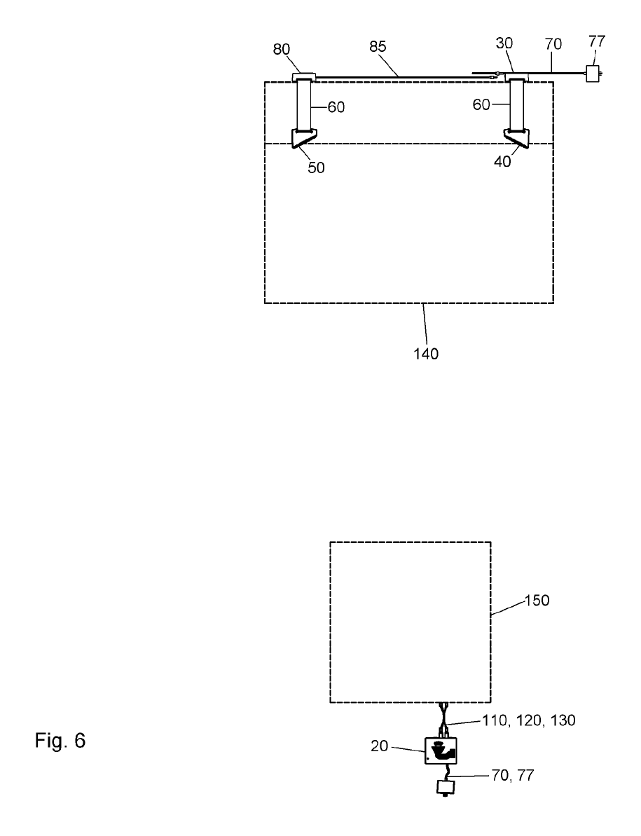

FIG. 7 is a top view and perspective view, as seen left to right, of the transmitter unit with inclusion of a power cable, an RCA audio cable, an optical audio cable, and a coaxial audio cable in these views.

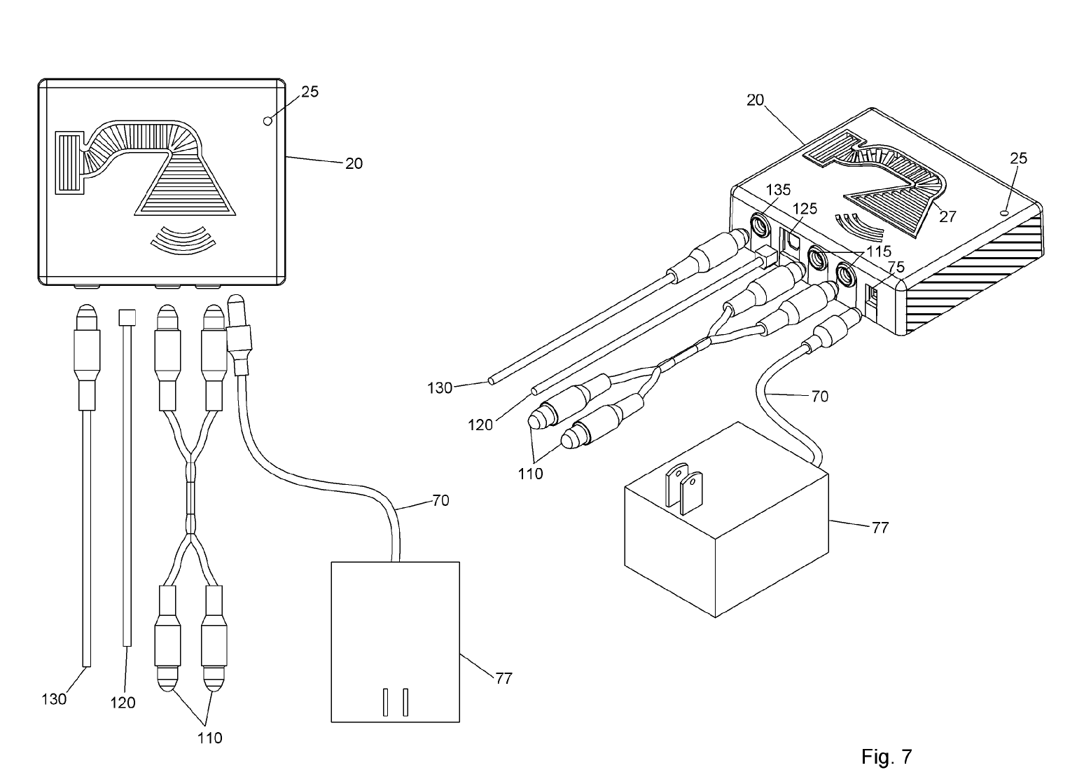

FIG. 8 is a top view of best mode receiver unit, power cable, and optional counter balance unit.

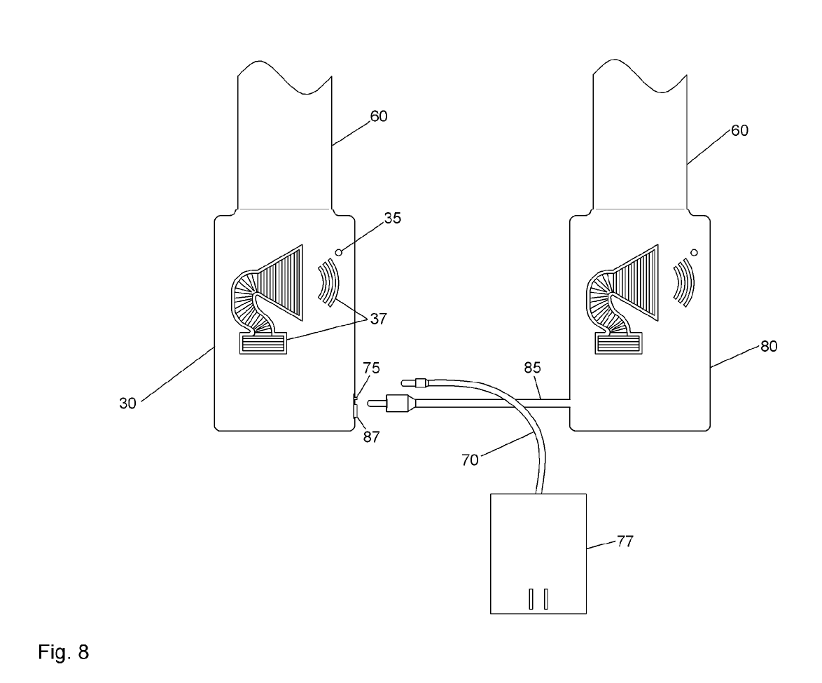

FIG. 9 is a perspective view of best mode receiver unit, power cable, and optional counter balance unit.

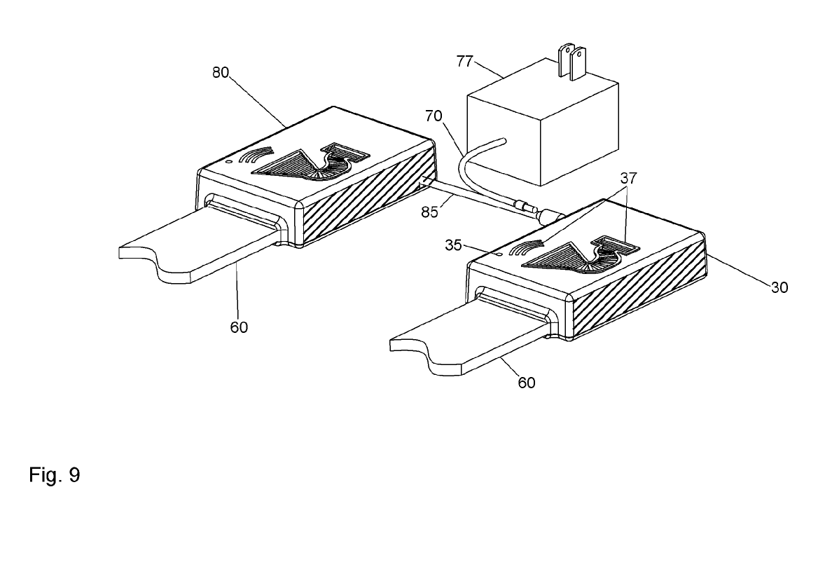

FIG. 10 is a perspective view of best mode receiver unit, power cable, and optional counter balance unit with blow-up of cable port connections on the receiver unit.

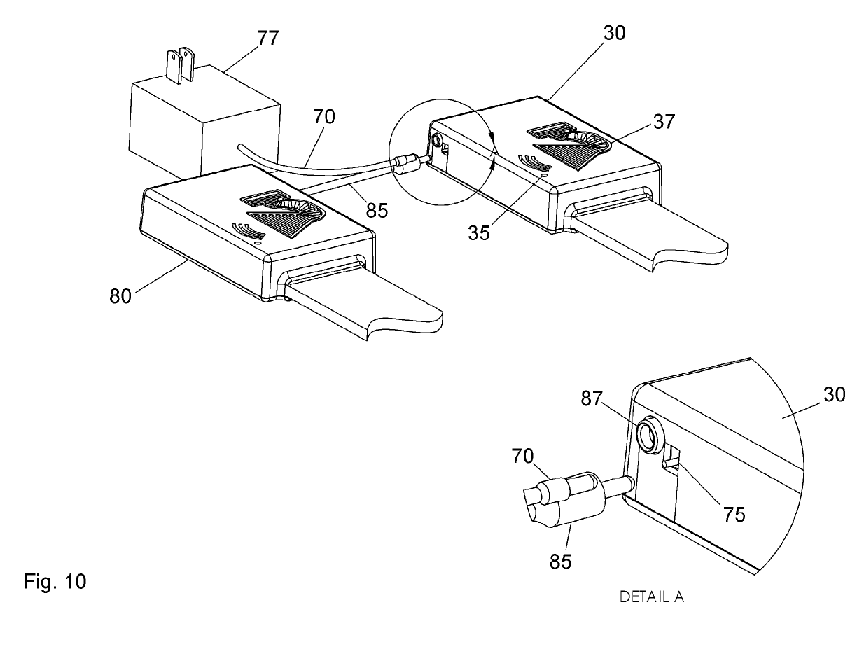

FIG. 11 is a bottom view and a perspective view, as seen left to right, of left speaker in best mode.

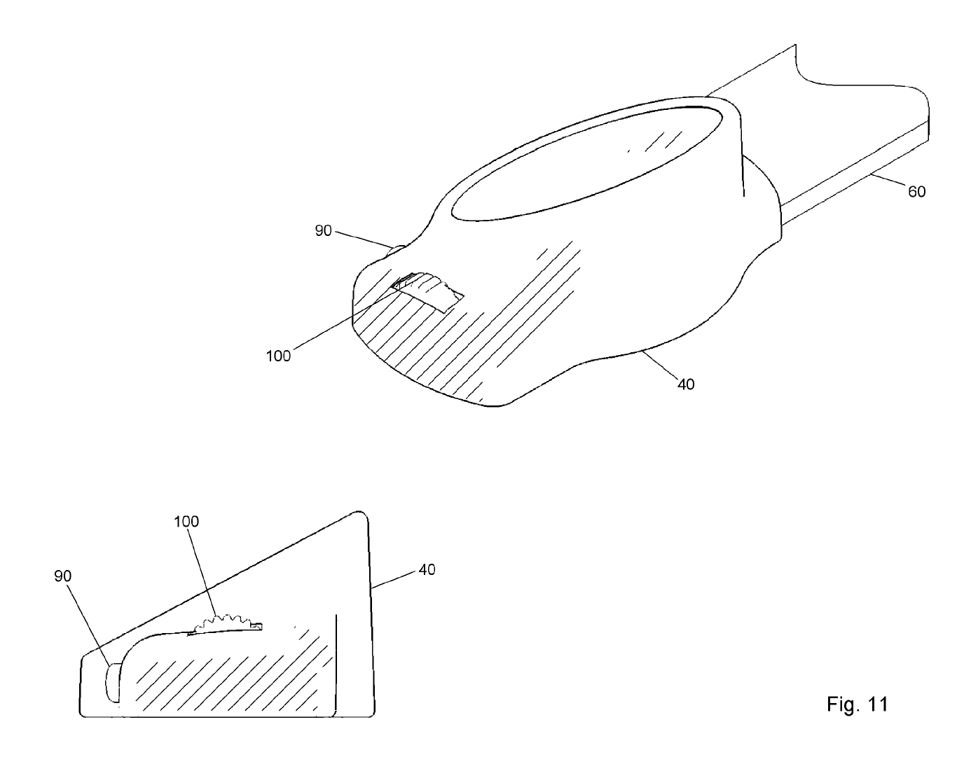

FIG. 12 is a side view and a perspective view, as seen left to right, of left speaker in best mode.

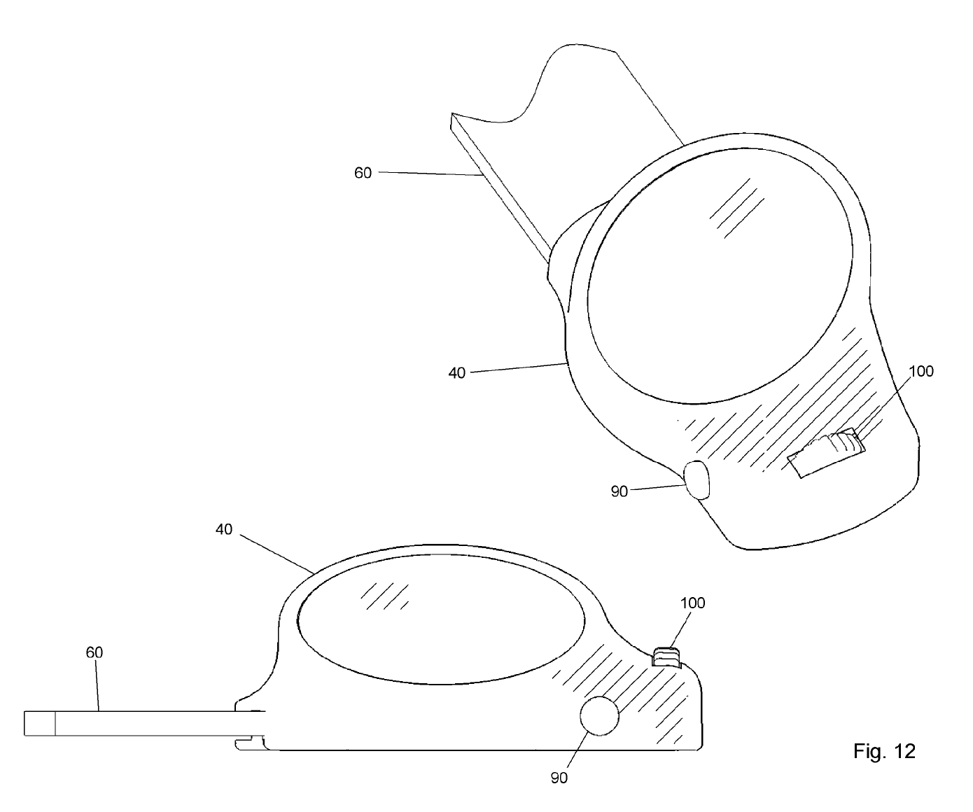

FIG. 13 is a front view and back view, as seen left to right, of left speaker in best mode.

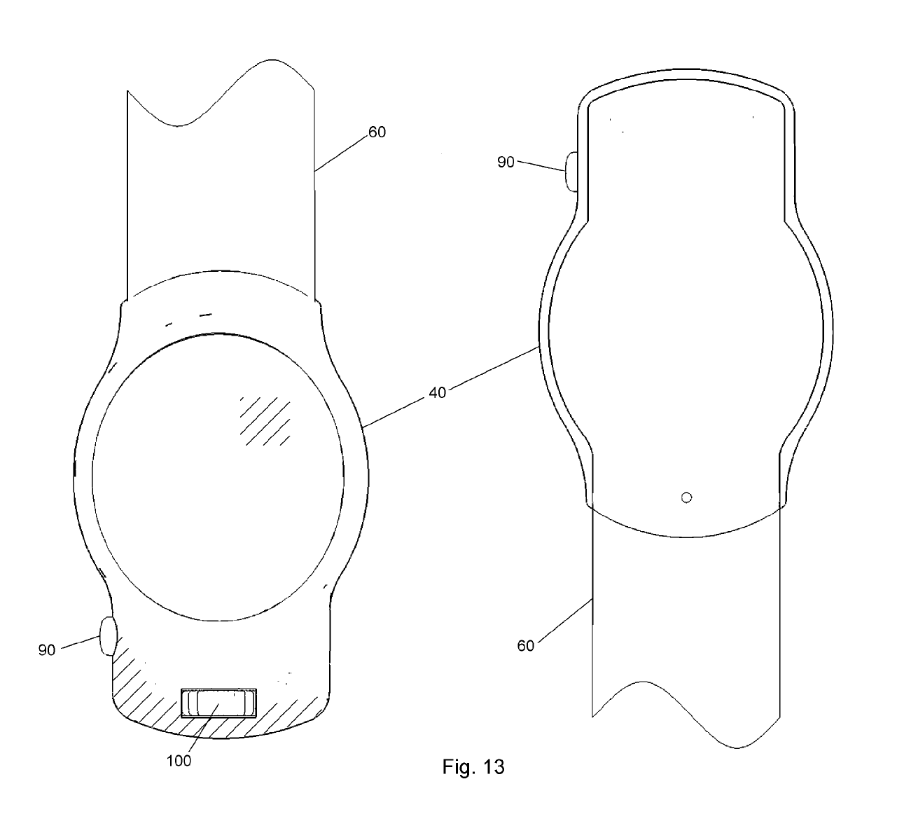

FIG. 14 is a side view and top view, as seen left to right, of left speaker in best mode.

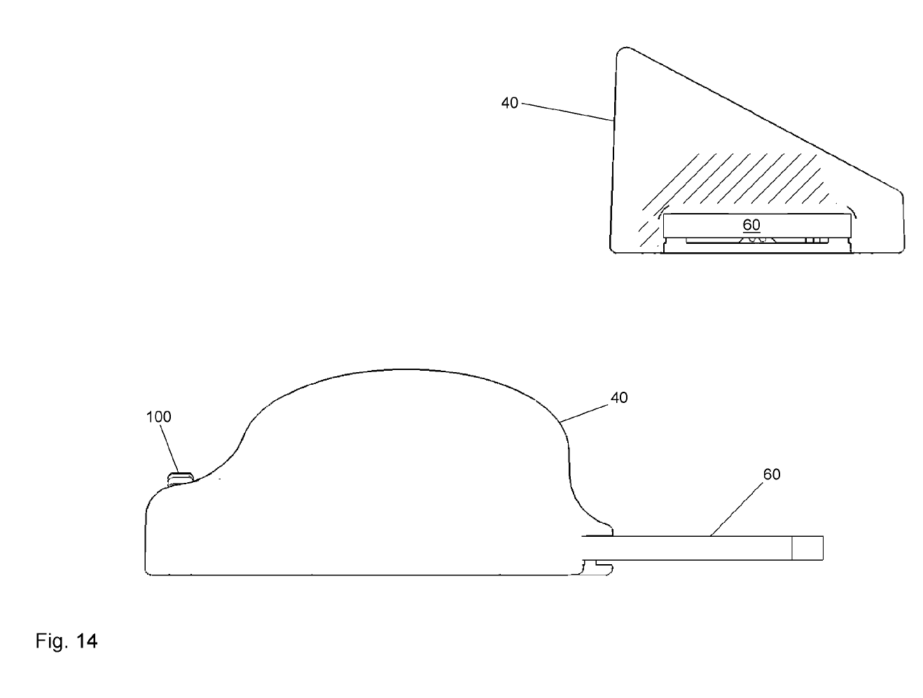

FIG. 15 is a bottom view and a prospective view, as seen left to right, of right speaker in best mode.

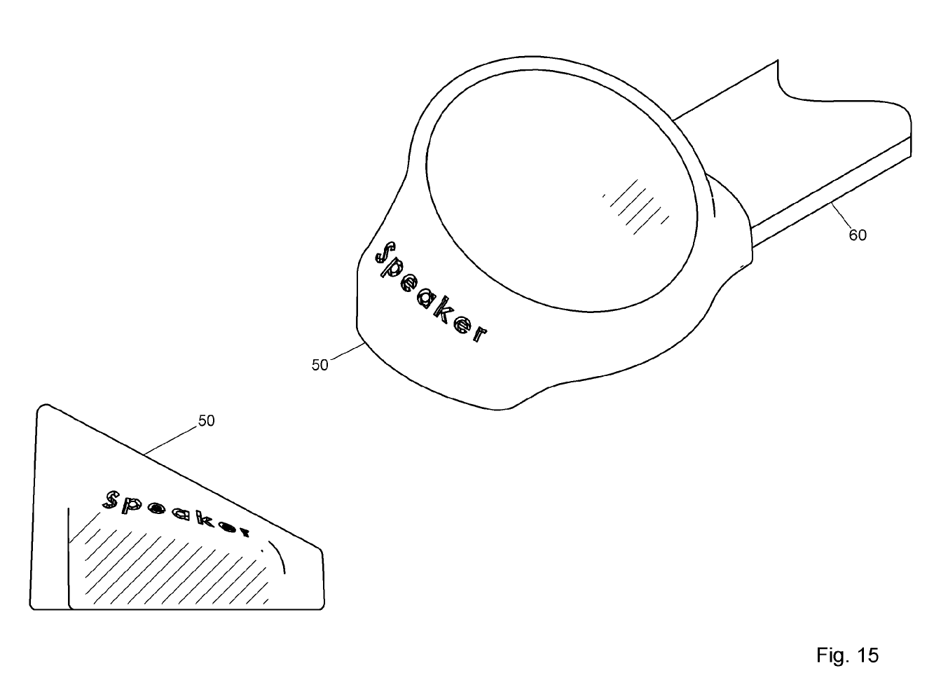

FIG. 16 is a front view and side view, as seen left to right, of right speaker in best mode.

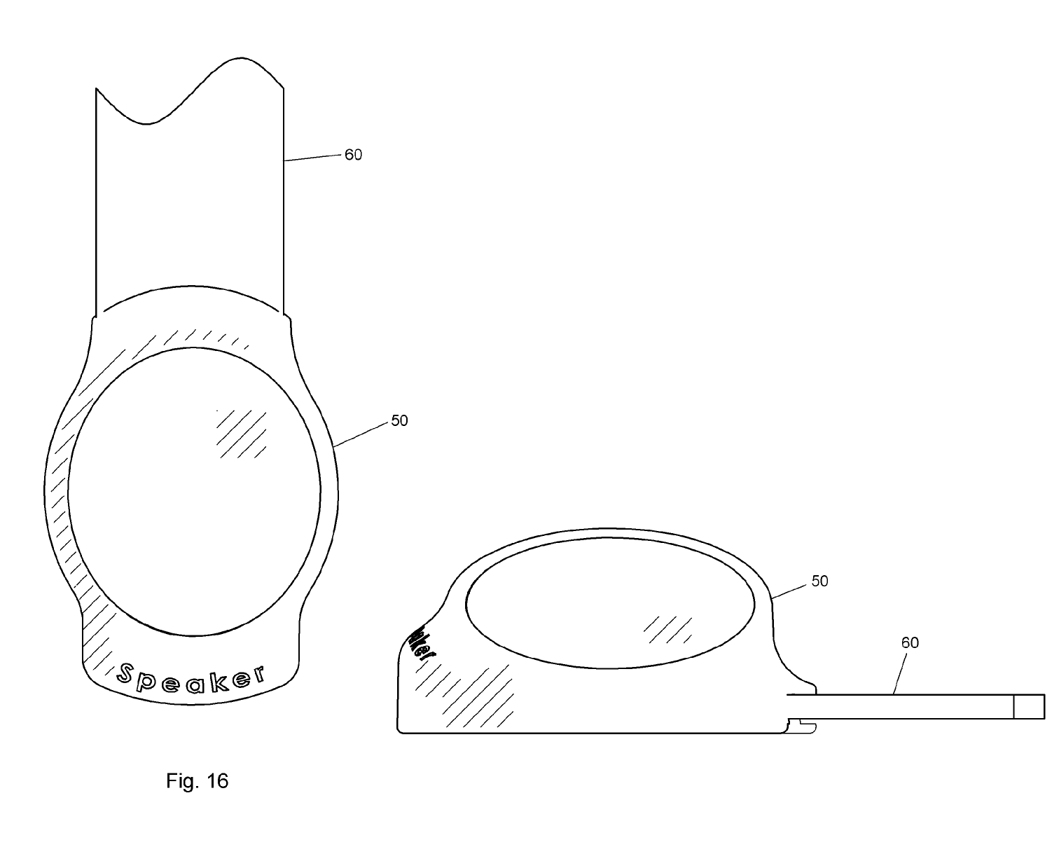

FIG. 17 is a side view and a prospective view, as seen left to right, of right speaker in best mode.

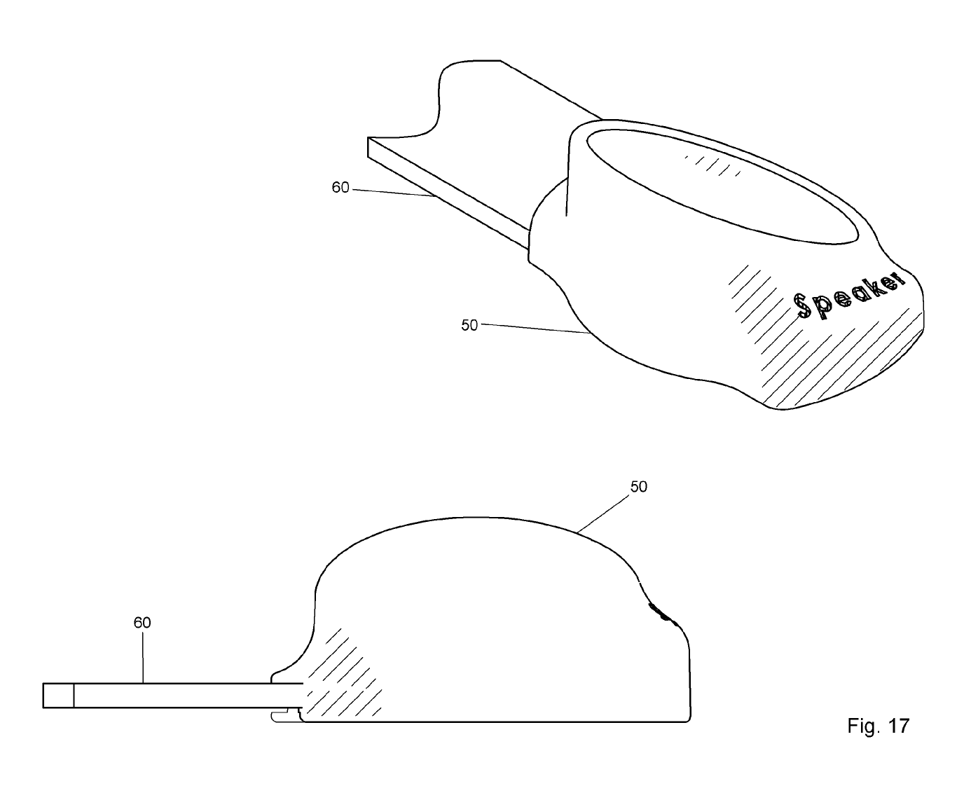

FIG. 18 is a top view and back view, as seen left to right, of right speaker in best mode.

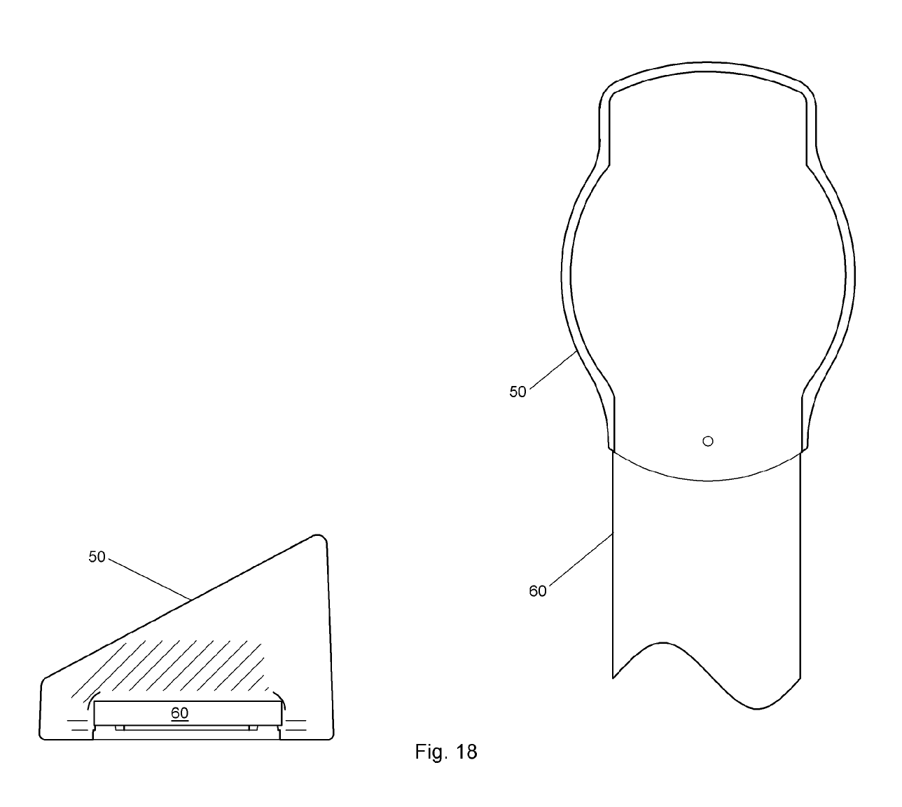

FIG. 19 is a circuit diagram of the audio signal attachment portion of the invention.

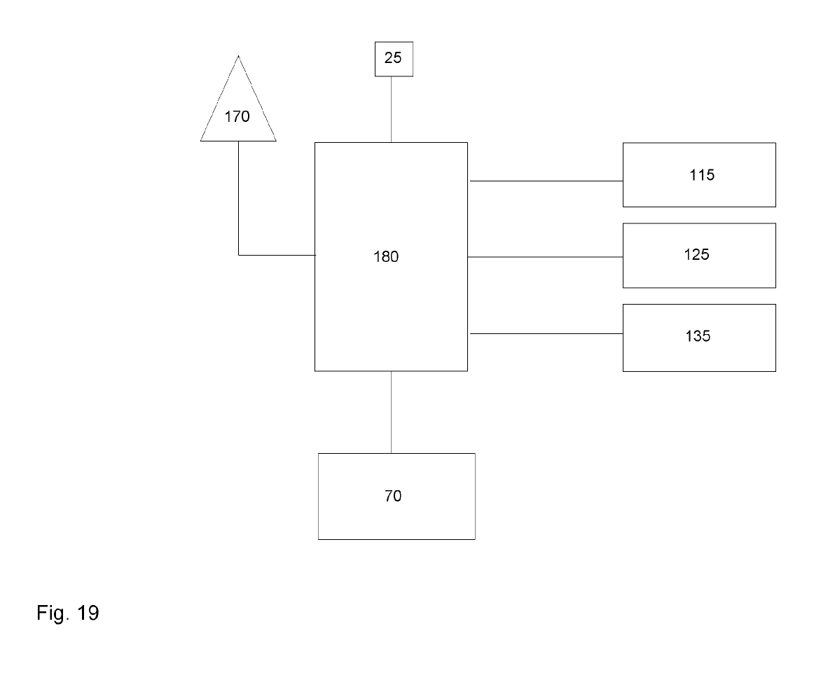

FIG. 20 is a circuit diagram of chair attachment portion of the invention.

### DEFINITION LIST

| Term | Definition |
|---|---|
| 10 | Chair-attachable wireless speaker system |
| 20 | Transmitter unit |
| 25 | Transmitter status LED |
| 27 | Transmitter unit cooling vents |
| 30 | Receiver unit |
| 35 | Receiver status LED |
| 37 | Receiver unit cooling vent |
| 40 | Speaker Unit |
| 50 | Additional speaker unit |
| 60 | At least one chair attach strap |
| 70 | Low voltage power supply |
| 75 | Low voltage power cord jack |
| 77 | AC to DC low voltage converter |
| 80 | Counter balance unit to go with additional speaker unit 40 |
| 85 | Speaker wire for counter balance unit |
| 87 | Speaker wire jack on receiver unit |
| 90 | Mute switch |
| 100 | Volume control switch |
| 110 | RCA audio cable |
| 115 | RCA audio cable jack input on transmitter unit |
| 120 | Optical audio cable |
| 125 | Optical audio cable jack input on transmitter unit |
| 130 | Coaxial audio cable |
| 135 | Coaxial audio cable jack input on transmitter unit |
| 140 | Easy Chair |
| 150 | Audio signal source |
| 160 | Digital radio frequency transmission with left and right audio |
| | signals encoded therein |
| 170 | Antenna |
| 180 | Transmitter module |
| 200 | Receiver module |
| 210 | Amplifier |
| 220 | Left speaker |
| 230 | Right speaker |

### DETAILED DESCRIPTION OF THE INVENTION

The invention comprises: a transmitter unit 20 with low voltage power supply 70, a receiver unit 30 with low voltage power supply 70, a speaker unit 40, and an at least one chair attach strap 60.

Chair attach strap 60 is long and wide, about 10-80 inches long and 1-6 inches wide. Chair attach strap 60 connects speaker unit 40 to receiver unit 30. Thus, strap 60 houses within it electrical wires transmitting analog sound signals and switching signals from the receiver unit 30 to the speaker unit 40. Electrical connections in strap 30 shall be of a sturdy design, capable of withstanding pulling on the ends without failure. Strap 60 is meant to hang over the top of the back of a chair 140. When system 10 is installed onto a chair 140, speaker unit 40 lies on the front of chair 140 and receiver unit 20 lies on the back of the chair 140. Chair attach strap 60 is typically thin, under and inch thick or so, but could be thicker without effect on strap function.

Strap 60 holds or reversibly attaches the speaker unit 40 to a chair 140. This is accomplished by positive pressure on from strap 60 onto the chair which holds speaker unit 40 onto chair 140. Positive pressure can be accomplished by multiple means, including many more than described here.

One means is to fabricate strap 60 out of spring material, or otherwise flexible material, into a bow shape, resembling the arc or arch of the top of a typical easy chair, but where strap arch is shaped to clamp down slightly on the back of the chair when the invention is installed on a chair. Thus, positive pressure is applied in this mode by the spring force produced by the shape and resiliency of strap spring material.

Another means is to fabricate strap 60 with a lower surface that is not slippery but rather is of high friction or a non-skid surface, so that strap 60 remains in tack on the chair back during small movement of the chair back as would occur from normal chair use. Lower surface may also be pleated or bunched up slightly to add friction. The strap 60 should be wide, as mentioned above, for this purpose. The upper surface of strap 60 may take on a decorative design and is not required to be non-skid. With this means, positive pressure results from the hanging of the speaker unit 40 on one side of the chair back while hanging the receiver unit 30 on the other side. Speaker unit 40 and receiver unit 30 should have about equal weight. Each should be sufficiently heavy enough to pull strap 60 down onto chair top, where the lower surface of strap 40 is held semi-firmly onto the upper surface of chair top by friction between the strap and the chair. Units 30 and 40 should each weigh about 2-16 ounces for this purpose.

The strap feature comes in two modes: a one-strap mode and a two-strap mode.

In one-strap mode, speaker unit 40 is attached to one end of strap 60 and receiver unit 30 is attached to the other end of strap 60. In one-strap mode, speaker unit 40 houses the left and right speakers 220 and 230. There is no additional speaker unit 50 or counter balance unit 80 in one-strap mode. Thus, both left and right speakers 220 and 230 are located on one side of the user's face while he is sitting in the chair.

In two-strap mode, there are two chair attach straps 60. There is an additional speaker unit 50 and a counter balance unit 80 in speaker system 10. Speaker unit 40 is attached to one end of one strap 60 and receiver unit 30 is attached to the other end of the same strap. Additional speaker unit 50 is attached to one end of the second strap 60 and counter balance unit 80 is attached to the other end of this strap. Thus, left speaker 220 is located in speaker unit 40 and right speaker 230 is located in additional speaker unit 50, or vice versa. To get appropriate hanging pressure, units 50 and 80 should also each weigh about 2-16 ounces. Additional speaker unit 50 is electrically connected to counter balance unit 80 through strap 60. Counter balance unit 80 is electrically connected to receiver unit 30 through speaker wire 85.

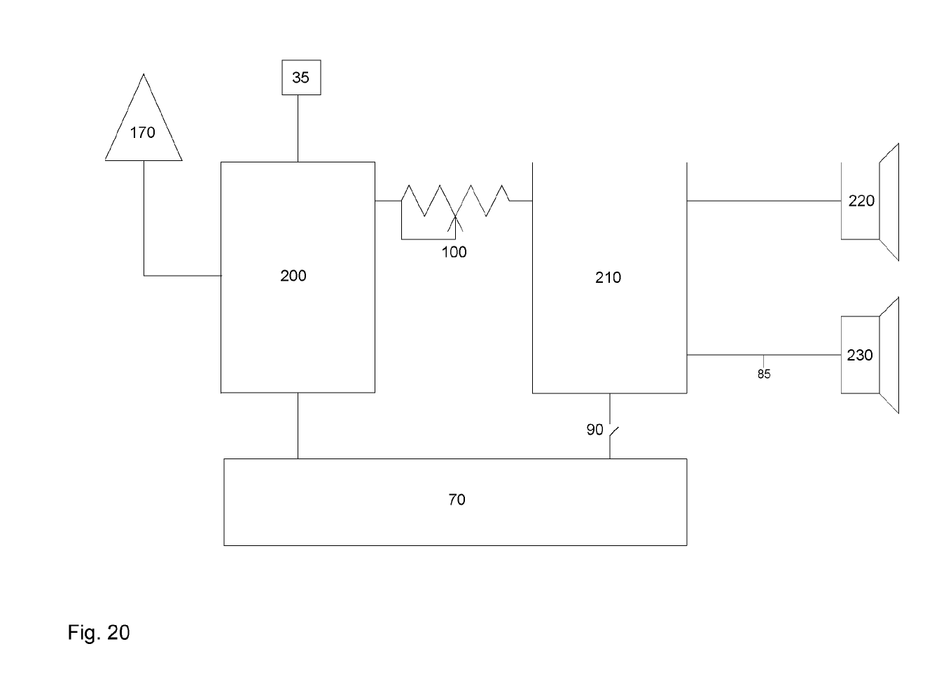

Referencing FIG. 20, circuit diagram of chair attachment portion, right speaker 230 may be located either in speaker unit 40 (one-strap mode) or additional speaker unit 50 (two strap mode). In the case of two-strap mode, speaker wire 85 would be represented by the electrical connection between amplifier 210 and speaker 230, and jack 87 would be located on the left end of this connection.

Two-strap mode is preferred over one-strap mode because with this mode the left speaker 220 can be positioned next to one of the user's ears and the right speaker 230 can be position next to the user's other ear. This speaker positioning could help ensure the user will hear the audio source connected to system 10 over all other noise which may be present in the room. Less dramatically, this speaker positioning could simply allow the user to enjoy listening to the audio source without disturbing others in the house who may not want to listen to the audio source. There are many other applications for this invention, including many that apply to the hearing impaired.

Best mode speaker units 40 and 50 include exterior shaping of each speaker unit to allow for more direct sound broadcast from each speaker to the ear. In best mode, speaker unit 40, located on the user's left side, has exterior shaping to position the relatively flat exterior plane of the speaker grill to be much more aligned and parallel with the exterior plane of the user's left ear. Likewise, in best mode, speaker unit 50, located on the user's right side, has exterior shaping to position the relatively flat exterior plane of the speaker grill to be much more aligned and parallel with the exterior plane of the user's right ear. This provides much more direct sound broadcast into the user's hears; thus sound waves are more incident onto the eardrums in this mode.

Speaker unit 40 further comprises a mute switch 90 and volume control switch 100. Mute switch 90 mutes speakers 220 and 230 by turning the receiver module 200 in the receiver unit 30 “on” and “off” by opening and closing the circuit between low voltage power supply 70 and receiver module 200. Volume control switch 100 variably adjusts the volume of speakers 220 and 230 by varying both input signals leading to amplifier 210.

Transmitter unit 20 comprises: a rigid enclosure, a transmitter module 180, a low voltage power supply 70, an antenna 170, at least one audio cable input jack. In best mode, at least one audio cable input jack comprises: an RCA stereo audio cable input jack 115, an optical audio cable input jack 125, and a coaxial audio cable input jack 135. The chosen audio input cable connects audio source 150 to transmitter module 180. Audio source 150 could be a TV, CD, DVD, Tuner, Receiver, Computer, Camera, PDA, or any device with audio output signal.

Transmitter module 180 is electrically connected to low voltage power supply 70. In best mode, a converter 77 is used to convert standard AC current from a home into low voltage DC current at 70. Transmitter module 180 is a circuit board comprising multiple integrated circuits and antenna 170. Transmitter module 180 and receiver module 200 are purchased in a pair commonly known as a wireless dongle box or wireless chip set. Various versions of such are readily commercially available. Transmitter module 180 electrically processes the left and right audio signals from audio source 150 and embeds said signals into a low power digital radio frequency transmission 160 with range of about 50 meters. Best mode radio frequency transmission range is 2406-2472 megahertz. Best mode transmitter module 180, when paired with its tandem receiver module 200, together electrically processes using a Gaussian frequency-shift keying where transmitted audio signals are filtered before playback through a Gaussian filter with shifting frequency in order to smooth positive/negative frequency deviations to provide clear speaker sound without distortion or interference. Transmitter module 180 can be purchased on the market and installed into the rigid enclosure. Jacks 115, 125, and 135 are electrically connected to the transmitter module 180 and also installed into the rigid enclosure. In best mode, rigid enclosure includes cooling vents 27. Cooling vents 27 allow transmitter unit 20 to ventilate heat from the unit caused by electrical processing of transmitter module 180. Transmitter unit 20 may optionally include a LED read-out 25 that indicates status of the transmitter module 180 using different colored lights.

Receiver unit 30 comprises: a rigid enclosure, a receiver module 200, a low voltage power supply 70, an antenna 170, an amplifier 210, optionally a mute switch 90, and optionally a volume switch 100. Receiver module 200 is a circuit board comprising multiple integrated circuits and antenna 170. Receiver module 200 receives the digital radio frequency transmission 160 and electrically processes it to decouple the left and right audio signals from audio source 150 for playback on speakers 220 and 230. Best mode receiver module 200, when paired with its tandem transmitter module 180, electrically processes using a Gaussian frequency-shift keying where the transmitted audio signal is filter before playback through a Gaussian filter with shifting frequency in order to smooth positive/negative frequency deviations to provide clear speaker sound without distortion or interference. Receiver module 200 can be purchased on the market and installed into the rigid enclosure. Jacks 75 and 87 are electrically connected to the receiver module 200 and also installed into the rigid enclosure. In best mode, rigid enclosure includes cooling vents 37. Cooling vents 37 allow receiver unit 30 to ventilate heat from the unit caused by electrical processing of receiver module 200. Receiver unit 30 may optionally include a LED read-out 35 that indicates status of the receiver module 200 using different colored lights.

What is claimed is:

1. A chair-attachable wireless speaker system comprising:
a transmitter unit, comprising: a transmitter module, a low voltage power supply, an antenna, and at least one audio cable input jack;
a receiver unit, comprising: a receiver module, a low voltage power supply, an antenna, and an amplifier;
a speaker unit, comprising at least one audio speaker;
a first chair attach strap; and
an attachment means to reversibly attach said first chair attach strap to the back of a chair; wherein,
said transmitter module is an integrated circuit, powered by said transmitter unit low voltage power supply, in radio frequency communication with said receiver module, another integrated circuit, powered by said receiver unit low voltage power supply, where said transmitter module is capable of wirelessly transmitting the audio signal from said at least one audio cable input jack, from said transmitter antenna to said receiver antenna, where said receiver module receives the audio signal, and sends it to said amplifier, powered by said receiver low voltage power supply, which amplifies the audio signal and sends the amplified audio signal to said at least one audio speaker of said speaker unit,
said first chair attach strap is a long wide strap about 10-80 inches long and 1-6 inches wide and has said receiver unit attached to one end and said speaker unit attached to the other end,
said first chair attach strap houses within it, a speaker wire, capable of transmitting the audio signal from said receiver unit to said speaker unit, and
said first chair attach strap has a lower surface with high coefficient of friction to help prevent said first chair attach strap from sliding along the chair back.

2. A chair-attachable wireless speaker system as recited in claim 1, wherein said attachment means results from said first chair attach strap being made of a semi-ridged resilient material or spring material shaped in a way to clamp down slightly on the chair back.

3. A chair-attachable wireless speaker system as recited in claim 1, wherein said attachment means results from said receiver unit and said speaker unit being of equal weights, ranging from about 2-16 ounces, so that when said speaker unit is placed in front of the chair back and said receiver unit is placed behind the chair back, the weights of said units cause said first chair attach strap to drape over the top of the chair back where gravity holds said first chair attach strap to remain attached to the chair back.

4. A chair-attachable wireless speaker system as recited in claim 1 wherein at least one audio cable input jack is: an RCA stereo audio cable input jack, an optical audio cable input jack, or a coaxial audio cable input jack.

5. A chair-attachable wireless speaker system as recited in claim 1 wherein said transmitter unit further comprises: an RCA stereo audio cable input jack, an optical audio cable input jack, and a coaxial audio cable input jack.

6. A chair-attachable wireless speaker system as recited in claim 1, further comprising:
an additional speaker unit, comprising at least one audio speaker;
a counter balance unit;
a second chair attach strap; and
an attachment means to reversibly attach said second chair attach strap to the back of a chair; wherein,
said second chair attach strap is a long wide strap about 10-80 inches long and 1-6 inches wide and has said counter balance unit attached to one end and said additional speaker unit attached to the other end,
said counter balance unit is electrically connected to said receiver unit,
said receiver unit sends an additional amplified audio signal to said at least one audio speaker of said additional speaker unit,
said second chair attach strap houses within it, a speaker wire, capable of transmitting the audio signal from said counter balance unit to said second speaker unit, and
said second chair attach strap has a lower surface with high coefficient of friction to help prevent said second chair attach strap from sliding along the chair back.

7. A chair-attachable wireless speaker system as recited in claim 6, wherein said attachment means results from said first and second chair attach straps being made of a semi-ridged resilient material or spring material shaped in a way to clamp down slightly on the chair back.

8. A chair-attachable wireless speaker system as recited in claim 6, wherein said attachment means results from said receiver unit, said speaker unit, said counter balance unit, and said additional speaker unit being of equal weights, ranging from about 2-16 ounces, so that when said speaker units are placed in front of the chair back and said receiver unit and counter balance unit are placed behind the chair back, the weights of said units cause said first and second chair attach straps to drape over the top of the chair back where gravity holds said straps to remain attached to the chair back.

9. A chair-attachable wireless speaker system as recited in claim 6 wherein at least one audio cable input jack is: an RCA stereo audio cable input jack, an optical audio cable input jack, or a coaxial audio cable input jack.

10. A chair-attachable wireless speaker system as recited in claim 6 wherein said transmitter unit further comprises: an RCA stereo audio cable input jack, an optical audio cable input jack, and a coaxial audio cable input jack.
